(19) United States
(12) Patent Application Publication
(10) Pub. No.: US 2001/0005258 A1
(43) Pub. Date: Jun. 28, 2001

(54) Liquid crystal element and layered type liquid crystal element

(76) Inventors: Nobuyuki Kobayashi, Kobe-shi (JP); Takuji Hatano, Suita-Shi (JP)

Correspondence Address: SIDLEY & AUSTIN, 717 NORTH HARWOOD, SUITE 3400, DALLAS, TX, 75201, US

(21) Appl. No.: 09/748,312

(22) Filed: Dec. 26, 2000

(30) Foreign Application Priority Data
Dec. 28, 1999 (JP) 11-375728

(51) Int. Cl. G02F 1/1333

(52) U.S. Cl. 349/158; 349/138

(57) ABSTRACT

A liquid crystal element, in which a liquid crystal layer is held between a pair of substrates, an electrode and a functional thin film such as an insulating film are formed on at least one of the substrates, and a refractive index difference between a largest refractive index and a smallest refractive index among refractive indexes of the substrate, the electrode formed on this substrate and the functional thin film formed on this substrate is in a range from 0 to 0.3.

A layered type liquid crystal element, in which a plurality of liquid crystal layers are layered, each of the liquid crystal layers is held between a pair of substrates, an electrode and a functional thin film are formed on at least one of the substrates, and a refractive index difference between a largest refractive index and a smallest refractive index among refractive indexes of the substrate, the electrode formed on this substrate and the functional thin film formed on this substrate is in a range from 0 to 0.3.

The present invention is based on patent application No. H11-375728 Pat. filed in Japan, the contents of which are hereby incorporated by reference.

### BACKGROUND OF THE INVENTION

1. Field of the Invention

The present invention relates to a liquid crystal element including a liquid crystal layer. The invention also relates to a layered type liquid crystal element including a plurality of liquid crystal layers layered together.

2. Description of the Background Art

A liquid crystal element has a pair of substrates and a liquid crystal layer held between the substrates.

The liquid crystal element is utilized, e.g., as a display element. By applying a voltage to the liquid crystal layer, the orientation of liquid crystal molecules in the liquid crystal layer is controlled so that light coming into the liquid crystal element is, e.g., modulated. Thereby, an intended image can be displayed.

For applying the voltage to the liquid crystal layer, electrodes are formed on the paired substrates holding the liquid crystal layer therebetween, respectively. In addition to the electrode, a thin film (functional thin film) having a function of achieving a predetermined object may be arranged on the substrate. For example, an insulating film(s) (insulating layer(s)) may be arranged on one of or both of the substrates for maintaining an electrical insulation between the electrodes arranged on the substrates.

For performing multicolor display, a layered type liquid crystal element having a plurality of liquid crystal layers, which are layered together for performing display in predetermined colors, respectively, is sometimes employed. In this layered type liquid crystal element, each liquid crystal layer is likewise held between the paired substrates. An electrode for applying a voltage to the liquid crystal layer is arranged on each substrate. The layered type liquid crystal element may likewise employ a functional thin film arranged on the substrate in addition to the electrode. For example, an insulating film(s) may be arranged on one of or both of the paired substrates holding the liquid crystal layer therebetween for keeping the electrical insulation between the electrodes.

The liquid crystal element using as a display element is required to perform bright display with high contrast for enabling good image display. Likewise, the layered type liquid crystal element using as a display element is required to perform bright display with high contrast for enabling good image display.

For improving the contrast of the liquid crystal element and the layered type liquid crystal element, various proposals have been made. However, further improvement is still demanded or desired.

### SUMMARY OF THE INVENTION

The inventors have made research relative to the substrates holding the liquid crystal layer as well as the electrodes and functional thin films such as insulating films formed on the substrates, and have developed the present invention.

An object of the invention is to provide a liquid crystal element, in which-a liquid crystal layer is held between a pair of substrates, an electrode and a functional thin film such as an insulating film are formed on at least one of the substrates, and particularly to provide the liquid crystal element which can achieve good contrast.

Another object of the invention is to provide a layered type liquid crystal element, in which a plurality of liquid crystal layers are layered, each liquid crystal layer is held between a pair of substrates,, an electrode and a functional thin film such as an insulating film are formed on at least one of the substrates, and particularly to provide the layered type liquid crystal element which can achieve good contrast.

The invention provides a liquid crystal element and a layered type liquid crystal element described below.

(1) Liquid Crystal Element

A liquid crystal element, in which a liquid crystal layer is held between a pair of substrates, an electrode and a functional thin film are formed on at least one of the substrates, and a refractive index difference between a largest refractive index and a smallest refractive index among refractive indexes of the substrate, the electrode formed on this substrate and the functional thin film formed on this substrate is in a range from 0 to 0.3.

(2) Layered Type Liquid Crystal Element

A layered type liquid crystal element, in which a plurality of liquid crystal layers are layered, each of the liquid crystal layers is held between a pair of substrates, an electrode and a functional thin film are formed on at least one of the substrates, and a refractive index difference between a largest refractive index and a smallest refractive index among refractive indexes of the substrate, the electrode formed on this substrate and the functional thin film formed on this substrate is in a range from 0 to 0.3.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section showing an example of a liquid crystal element according to the invention;

FIG. 2 is a schematic cross section showing an example of a layered type liquid crystal element according to the invention;

FIG. 3 is a schematic cross section showing another example of a layered type liquid crystal element according to the invention;

FIG. 4 is a schematic cross section showing still another example of a layered type liquid crystal element according to the invention;

FIG. 5 shows an example of a fixing device; and

FIG. 6 shows an example of a display drive control device of the liquid crystal element (liquid crystal cell).

### DESCRIPTION OF THE PREFERRED EMBODIMENTS

(1) Liquid Crystal Element

As a preferred embodiment, the invention provides the following liquid crystal element.

A liquid crystal element, in which a liquid crystal layer is held between a pair of substrates, an electrode and a functional thin film are formed on at least one of the substrates, and a refractive index difference between a largest refractive index and a smallest refractive index among refractive indexes of the substrate, the electrode formed on this substrate and the functional thin film formed on this substrate is in a range from 0 to 0.3.

This liquid crystal element can be used, for example, as a display element of a reflection type. This liquid crystal element has the following structure.

The liquid crystal element has the liquid crystal layer. The liquid crystal layer includes liquid crystal (liquid crystal composition). The liquid crystal layer is held between the paired substrates.

The electrodes are formed on the paired substrates holding the liquid crystal layer, respectively. The electrode may be a transparent electrode. In addition to the electrode, a thin film (functional thin film) having a function of achieving a predetermined object is formed on at least one of the paired substrates holding the liquid crystal layer. Thus, the electrode and the functional thin film are formed on at least one of the paired substrates holding the liquid crystal layer.

Typically, the functional thin film is an insulating film for keeping the electrical insulation between the electrodes. The function of the functional thin film is not restricted to the insulation. The functional thin film may have two or more functions. The functional thin film may have the insulating property as well as other function(s).

If necessary, an orientation film, a gas barrier layer, a filter layer or others may be formed on the substrate holding the liquid crystal layer.

In the foregoing liquid crystal element, the refractive index difference between the largest refractive index and the smallest refractive index among the refractive indexes of the substrate, the electrode formed on this substrate and the functional thin film formed on this substrate is in the range from 0 to 0.3. In other words, the refractive index difference is in the range from 0 to 0.3 between any two of the refractive indexes of the substrate, the electrode formed on this substrate and the functional thin film formed on this substrate.

In the following description, the refractive index difference between the largest refractive index and the smallest refractive index among the refractive indexes of the substrate, the electrode formed on this substrate and the functional thin film formed on this substrate, may be referred to as a “refractive index difference between the substrate, electrode and functional thin film”, or may be merely referred to as a “refractive index difference”, hereinafter.

In the case where the liquid crystal element is utilized as a display element of the reflection type, not only each of the refractive indexes of the substrate, electrode and functional thin film but also the relationship between these refractive indexes are important for improving the contrast.

The refractive index difference between the substrate, electrode and functional thin film particularly affects the reflective index of the liquid crystal element when the liquid crystal layer is in the transparent state. Accordingly, this refractive index difference affects the contrast. As the refractive index difference decreases toward zero, the contrast is improved, as can be seen from experimental results which will be described later. As the refractive index difference increases, the reflection (e.g., irregular reflection) of light by the liquid crystal element becomes larger so that the reflective index of the liquid crystal element becomes higher when the liquid crystal layer is in the transparent state, and therefore the liquid crystal element has lower transparency when the liquid crystal layer is in the transparent state. As a result, the larger refractive index difference lowers the contrast of the liquid crystal element.

As already described, the refractive index difference in the foregoing liquid crystal element is in a range from 0 to 0.3. As can be seen from the experimental results to be described later, if the refractive index difference is equal to or smaller than 0.3, the contrast is relatively high. If the refractive index difference is equal to or smaller than 0.3, it is possible to suppress the light reflection of the liquid crystal element when the liquid crystal layer is in the transparent state, and the transparency of the whole liquid crystal element increases so that the contrast can be high. As already described, the refractive index difference closer to zero can provide higher contrast. The most preferable value of the refractive index difference is zero from the viewpoint of improvement of the contrast.

In the foregoing liquid crystal element, the electrode and the functional thin film may be arranged on each of the paired substrates holding the liquid crystal layer therebetween. In this case, if at least one of the refractive index differences, each of which is the refractive index difference between the substrate, the electrode on this substrate and the functional thin film on this substrate, is in the range from 0 to 0.3, the contrast can be improved. If only one of the refractive index differences is set to be in a range from 0 to 0.3, it is preferable that the refractive index difference with respect to the substrate located on an observation side is in a range from 0 to 0.3, because the contrast is affected more significantly by the refractive index difference between the substrate on the observation side, the electrode on this substrate and the functional thin on this substrate. If the electrode and the functional thin film are formed on each of the paired substrates holding the liquid crystal layer therebetween, it is preferable that each of the refractive index differences is in a range from 0 to 0.3.

(2) Layered Type Liquid Crystal Element

As an preferred embodiment, the invention provides the following layered type liquid crystal element.

A layered type liquid crystal element, in which a plurality of liquid crystal layers are layered, each of the liquid crystal layers is held between a pair of substrates, an electrode and a functional thin film are formed on at least one of the substrates, and a refractive index difference between a largest refractive index and a smallest refractive index among refractive indexes of the substrate, the electrode formed on this substrate and the functional thin film formed on this substrate is in a range from 0 to 0.3.

This layered type liquid crystal element can be used, for example, as a display element of a reflection type.

This layered type liquid crystal element has the following structure.

This layered type liquid crystal element has the plurality of liquid crystal layers, which are layered together.

Each liquid crystal layer includes liquid crystal (liquid crystal composition). Each liquid crystal layer is held between the paired substrates.

For each of the liquid crystal layer, there are provided the electrodes are provided. Each of the electrodes is formed on the substrate holding the liquid crystal layer, and is opposed to this liquid crystal layer. Accordingly, on each of the substrate, in the layered type liquid crystal element, for holding the liquid crystal layer, the electrode is formed in the position opposed to this liquid crystal layer. The electrode may be a transparent electrode. In addition to the electrode, the functional thin film is formed on at least one of the plurality of substrates in the layered type liquid crystal element.

Typically, the functional thin film is an insulating film for keeping the electrical insulation between the electrodes. The function of the functional thin film is not restricted to the insulation. The functional thin film may have two or more functions. The functional thin film may have the insulating property as well as other function(s).

If necessary, an orientation film, a gas barrier layer, a filter layer or the others may be formed on the substrate holding the liquid crystal layer.

The layered type liquid crystal element may be formed of a plurality of liquid crystal cells, each of which is the liquid crystal element having the structure described in the foregoing item (1), layered together. In the layered type liquid crystal element having the plurality of liquid crystal cells layered together, two substrates are arranged between the neighboring liquid crystal layers. In the layered type liquid crystal element, only one substrate may be arranged between the neighboring liquid crystal layers, and may be used commonly for holding these neighboring liquid crystal layers. Thus, in the layered type liquid crystal element, the substrate for holding one of the liquid crystal layers may be used for holding another liquid crystal layer.

In any one of the foregoing cases, each of the plurality of substrates in the layered type liquid crystal element is provided with the electrode as described before, and at least one of the substrates is further provided with the functional thin film.

The layered type liquid crystal element described above may include, e.g., three or more liquid crystal layers layered together. The layered type liquid crystal element may have layered three liquid crystal layers, i.e., the liquid crystal layer (R-liquid crystal layer) having a selective reflection wavelength in a red region, the liquid crystal layer (G-liquid crystal layer) having a selective reflection wavelength in a green region, and the liquid crystal layer (B-liquid crystal layer) having a selective reflection wavelength in a blue region. The layered type liquid crystal element including the three, i.e., R-, G- and B-li,quid crystal layers layered together may be referred to as an “RGB layered type liquid crystal element”, hereinafter. This RGB layered type liquid crystal element may be used, e.g., as a color liquid crystal display element of a reflection type.

In the foregoing layered type liquid crystal element, similarly to the liquid crystal element described in the foregoing item (1), the refractive index difference between the largest refractive index and the smallest refractive index among the refractive indexes of the substrate, the electrode formed on this substrate and the functional thin film formed on this substrate is in the range from 0 to 0.3. Accordingly, similarly to the liquid crystal element as already described, the layered type liquid crystal element of the invention can perform display with relatively high contrast.

In the foregoing layered type liquid crystal element, the electrode and the functional thin film may be formed on each of a plurality of substrates among all the substrates in the layered type liquid crystal element. In this case, the contrast can be improved if at least one of the refractive index differences, each of which is the refractive index difference between the substrate, the electrode on this substrate and the functional thin film on this substrate, is in above range from 0 to 0.3.

In the foregoing layered type liquid crystal element, in the case where the electrode and the functional thin film are formed on at least one of paired substrates in each substrate pair for holding the liquid crystal layer, the largest influence on the contrast is exerted by the refractive index difference with respect to the substrate for holding the liquid crystal layer located nearest to the observation side. In this case, therefore, it Ls preferable that the refractive index difference between the substrate for holding the liquid crystal layer located nearest to the observation side, the electrode on this substrate and functional thin film on this substrate is in the above range from 0 to 0.3. Also in this case, it is preferable for improving the contrast that the refractive index difference with respect to each of the substrate on which the electrode and the functional thin film is formed is in the range from 0 to 0.3.

In the layered type liquid crystal element described above, in the case where the electrode and the functional thin film are formed each of the paired substrates for holding the liquid crystal layer, at least one of the refractive index differences with respect to above paired substrates may be in the range from 0 to 0.3. If only one of the refractive index differences is set to be in the range from 0 to 0.3, it is preferable that the refractive index difference with respect to the substrate arranged near the observation side is in the range from 0 to 0.3, as already described in the item (1).

(3) In the liquid crystal element and the layered type liquid crystal element described above, the substrate may be a resin substrate made of resin such as polyether sulfone (PES), polycarbonate (PC), polyethylene terephthalate (PET), polyarylate (PA) or polyether ether ketone (PEEK). The substrate may be made of plastics. The substrate may be made of glass. The refractive index of the substrate may be in a range from 1.55 to 1.7, although this depends on the refractive indexes of the electrode and the functional thin film (e.g., insulating film). The refractive index of the substrate may be adjusted by changing the substrate material.

In the liquid crystal element and the layered type liquid crystal element described above, the electrode may be a transparent electrode. The electrode may be an electrically conductive transparent film made of, e.g., ITO (Indium Tin Oxide), a metal electrode made of aluminum, silicon or the like, or a photoconductive film made of amorphous silicon, BSO (Bismuth Silicon Oxide) or the like. The refractive index of the electrode may be in a range from 1.6 to 2.4, although depending on the refractive indexes of the substrate and the functional thin film. If the electrode is made of, e.g., ITO, the refractive index of the electrode can be adjusted, e.g., by an amount of added oxygen, In and/or Sn. In this case, the refractive index of the electrode can be adjusted most easily by adjusting the amount of the oxygen.

In the liquid crystal element and the layered type liquid crystal element described above, the functional thin film may be an insulating film, as described above. The refractive index of the functional thin film (e.g., insulating film) may be in a range from 1.4 to 2.0, although depending on the refractive indexes of the substrates and the electrode. If the functional thin film is the insulating film, the insulating film may be made of silicon-contained material. If the insulating film is made of, e.g., an inorganic material-contained material, the refractive index of the insulating film can be adjusted by changing, e.g., the kind of an agent added to an inorganic base material (silicon-contained material in the case where the insulating film is made of the silicon-contained material). In the case of employing of the organic material for the insulating layer, the refractive index of the insulating film can be adjusted by changing the kind of the organic material to be used.

In the liquid crystal element and the layered type liquid crystal element described above, the liquid crystal layer may include spacers for adjusting the thickness of the liquid crystal (liquid crystal layer). The liquid crystal layer may include resin structures for adhering together the substrates holding the liquid crystal layer therebetween, and/or for increasing the strength of the whole liquid crystal element. The liquid crystal layer may be a so-called liquid crystal composite film of a polymer-dispersed type. The liquid crystal composite film of the polymer-dispersed type may have such a structure that the liquid crystal is dispersed in the three-dimensional net-like structure of polymers, or three-dimensional net-like structure is formed within the liquid crystal.

In the liquid crystal element and the layered type liquid crystal element described above, the liquid crystal (liquid crystal composition) in the liquid crystal layer may be a liquid crystal composition including a liquid crystal exhibiting a cholesteric phase, e.g., in a room temperature. Dye(s) may be added to the liquid crystal composition in the liquid crystal layer. The liquid crystal exhibiting the cholesteric phase selectively reflects the light of the wavelength depending on the helical pitch of liquid crystal. Therefore, the liquid crystal element including the liquid crystal exhibiting the cholesteric phase can be used as the liquid crystal display element of the reflection type. Similarly, the layered type liquid crystal element having a layered structure of the plurality of liquid crystal layers, each including the liquid crystal exhibiting the cholesteric phase, can be utilized as the liquid crystal display element of the reflection type.

The liquid crystal exhibiting the cholesteric phase may be a cholesteric liquid crystal which exhibits the cholesteric phase by itself, or a chiral nematic liquid crystal composition including a nematic liquid crystal composition and a chiral agent added thereto. The chiral nematic liquid crystal composition has such an advantage that the helical pitch can be adjusted by controlling an amount of the added chiral agent, and thereby the selective reflection wavelength can be easily adjusted. The helical pitch is a pitch of a spiral structure of the liquid crystal molecules, and is a distance between the liquid crystal molecules twisted by 360 degrees from each other along the spiral structure of the liquid crystal molecules. The selective reflection wavelength may be set in a visible light; range or an invisible light range (e.g., infrared ray range).

The nematic liquid crystal composition has rod-like liquid crystal molecules which are parallel to each other, but does not have a layered structure. The nematic liquid crystal composition for the chiral nematic liquid crystal composition is not restricted to a specific nematic composition, and various kinds of nematic compositions can be used as the nematic liquid crystal composition for the chiral nematic liquid crystal composition. In particular, the nematic liquid crystal composition including the liquid crystal compound having a polar group such as liquid crystal ester compound, liquid crystal pyrimidine compound, liquid crystal cyanobiphenyl compound, liquid crystal cyanophenylcyclohexane compound, liquid crystal cynanoterphenyl compound, liquid crystal difluorostilbene compound or liquid crystal tolane compound, is useful because it can increase the dielectric anisotropy of the chiral nematic liquid crystal composition. The nematic liquid crystal composition may be a mixture of two or more kinds of liquid crystal compound. The nematic liquid crystal composition may contain liquid crystal compounds other than the above, and more specifically may contain a polycyclic compound or an N-type compound for increasing a temperature of phase transition to an isotropic phase.

The chiral agent is an additive having a function of twisting the molecules of nematic liquid crystal composition. By adding the chiral agent to the nematic liquid crystal composition, the liquid crystal molecules can have the spiral structure which has a twist distance depending on the amount of added chiral agent. As a result, the liquid crystal composition containing the nematic liquid crystal composition and the chiral agent added thereto can exhibit the cholesteric phase.

The chiral agent may contain at least one kind of compound having at least one asymmetry carbon, and the helical senses (twist directions of the liquid crystal composition) thereof may be uniform or different. The addition rate of the chiral agent is preferably 4% or less by weight with respect to the nematic liquid crystal composition, and 40% or less by weight is more preferable. If the addition rate exceeds 45% by weight, the disadvantages such as precipitation of crystal is liable to occur. The lower limit of the addition rate of chiral agent is not particularly restricted if an intended effect can be achieved, but is 10% or more by weight is preferably.

Two or more kinds of chiral agents may add to the nematic liquid crystal composition. Two or more kinds of chiral agents having the same optical rotation, alternatively, two or more kinds of chiral agents having different optical rotations may add to the nematic liquid crystal composition. By adding two or more kinds of chiral agents to the nematic liquid crystal composition and/or by adding the liquid crystal components such as a polycyclic compound and an N-type compound, it is possible to change the phase transition temperature of the chiral nematic liquid crystal composition and suppress the change in selective reflection wavelength due to change in temperature. Also, it is possible to change the properties of the chiral nematic liquid crystal composition such as a dielectric anisotropy, refractive index anisotropy and viscosity. Thereby, properties of the liquid crystal display element can be improved.

In the liquid crystal element and the layered type liquid crystal element described above, dye(s) may be added to the element component, and/or a colored filter layer (filter layer) such as a color glass filter or color film may be provided, for improving the purity of color displayed when the incident light is selectively reflected, and/or for absorbing the light components which may lower the transparency of the liquid crystal composition in the transparent state. The dye(s) may be added to the liquid crystal composition, resin material, electrode material and/or substrate material. For preventing the lowering of the display quality, it is preferable that the dye(s) and the colored filter layer do not impede the color display performed by the selective reflection.

Examples of the liquid crystal element and the layered type liquid crystal element will now be described with reference to the drawings.

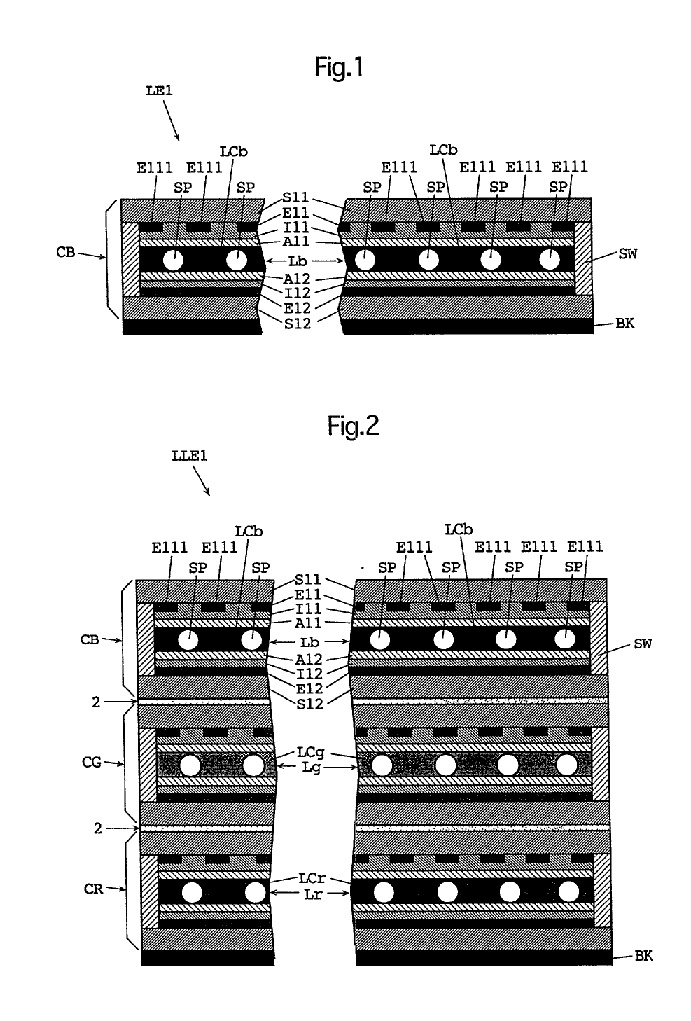

(1) FIG. 1 is a schematic cross section of an example of a liquid crystal element.

In this example, a liquid crystal element E1 shown in FIG. 1 is utilized as a display element of the reflection type, and a displayed image of this display element is observed from an upper side of the liquid crystal element LE1 in FIG. 1.

As will be described later in greater detail, the liquid crystal element LE1 includes a liquid crystal (liquid crystal composition) LCb having a selective reflection wavelength in a visible light range. If the liquid crystal LCb has the selective reflection wavelength, e.g., in the blue region, the liquid crystal element LE1 is used for blue display.

The liquid crystal element LE1 has a pair of substrates S11 and S12, and a liquid crystal layer Lb held between the substrates. A black light absorbing layer BK is arranged on the outer side of the substrate S12, which is located on the side remote from the observation side.

In this example, the substrates S11 and S12 are transparent film substrates made of resin, respectively. The transparent substrate may be made of polyether sulfone (PES), polycarbonate (PC), polyethylene terephthalate (PET), polyarylate (PA) or polyether ether ketone (PEEK). The substrate may be a glass substrate.

A transparent electrode E11, an insulating film (insulating layer) I11 as a functional thin film and an orientation film (alignment film) A11 are successively formed on the substrate S11. In this example, the electrode E11 is formed of a plurality of belt-like electrode portions E111, which are parallel to each other with a predetermined space therebetween. The transparent electrode may be a transparent conductive film made of, e.g., ITO (Indium Tin Oxide), a metal electrode made of, e.g., aluminum or silicon, a photo-conductive film made of, e.g., BSO (Bismuth Silicon Oxide) or the like. The orientation film may be typically made of polyimide.

A transparent electrode E12, an insulating film I12 as a functional thin film and an orientation film A12 are successively formed on the substrate S12. Although not shown, the electrode E12 is formed of a plurality of belt-like electrode portions, which are parallel to each other with a predetermined space therebetween. The belt-like electrode portions of the electrode E12 extend across the belt-like electrode portions E111 of the electrode E11 so that these belt-like electrode portions form a so-called matrix structure.

The insulating films I11 and I12, which are arranged on the substrates S11 and S12, respectively, are provided for keeping electrical insulation between the electrodes E11 and E12. The insulating film may be an inorganic film made of silicon oxide or the like, or an organic film made of polyimide resin, epoxy resin or the like. In the liquid crystal element LE1, the insulating film is arranged on each of the substrates holding the liquid crystal layer Lb therebetween. However, the insulating film may be arranged on only one of the paired substrates.

As described above, the liquid crystal layer Lb is arranged between the substrates S11 and S12, each on which the electrode, insulating film and orientation film are formed.

The liquid crystal layer Lb in this example includes the liquid crystal LCb and spherical spacers SP.

The spacers SP are arranged between the substrates (strictly speaking, between the orientation films) for controlling, e.g., the thickness of the liquid crystal. The spacers may be preferably formed of particles, which are made of a hard material having a sufficient deformation resistance against heat and pressure. The spacer may be made of, e.g., an inorganic material such as finely divided glass fibers, silicate glass in the ball-like form or alumina powder, or spheric particles of an organic material such as divinylbenzene-contained cross-linked polymer or polystyrene-contained cross-linked polymer.

For preventing leakage of the liquid crystal LCb from the peripheral portions of the substrates, a seal wall SW made of a resin material is arranged at the peripheral portion of the substrate. The seal wall SW is disposed between the substrates and has an annular or frame-like form.

The liquid crystal (liquid crystal composition) LCb in this example is a chiral nematic liquid crystal composition exhibiting the cholesteric phase in the room temperature. This chiral nematic liquid crystal composition includes a nematic liquid crystal composition and a chiral agent added thereto for obtaining an intended helical pitch, and more specifically for having an intended selective reflection wavelength. By adjusting the amount of chiral agent added to the nematic liquid crystal composition, the selective reflection wavelength of the chiral nematic liquid crystal composition can be adjusted. The selective wavelength of the liquid crystal LCb is set in the blue region in this embodiment.

When the liquid crystal composition exhibiting the cholesteric phase is in a planar state, wherein the helical axes are perpendicular to the substrate, the liquid crystal composition selectively reflects the light of a wavelength corresponding to a product of a helical pitch and an average refractive index of the liquid crystal composition. Accordingly, the liquid crystal composition in the planar state exhibits a color corresponding to the selective reflection wavelength if the selective reflection wavelength is in the visible range. By setting the selective reflection wavelength, e.g., in an infrared range, the liquid crystal composition in the planar state exhibits a transparent appearance.

The liquid crystal composition exhibiting the cholesteric phase scatters the light when the liquid crystal composition is in the focal conic state wherein the helical axes are oriented irregularly. This scattering causes an opaque appearance when the liquid crystal composition is in the focal conic state, and the helical pitch is larger than the visible light wavelength. The liquid crystal composition in the focal conic state exhibits a nearly transparent appearance if the helical pitch is short in such a case where the selective reflection wavelength is in the visible range, and thereby the scattering does not occur to a large extent.

Accordingly, by changing the state of the liquid crystal composition between the planar state and the focal conic state, the liquid crystal composition exhibiting the cholesteric phase assumes, e.g., the selective reflection state (planar state) or the transparent state (focal conic state). If the selective reflection wavelength is in the infrared range, the liquid crystal composition exhibiting the cholesteric phase assumes, e.g., the transparent state (planar state) or the opaque state (focal conic state) by changing the state of the liquid crystal composition between the planar state and the focal conic state. The liquid crystal composition exhibiting the cholesteric phase can assume the state where the planar state and the focal conic state are mixed.

The state of the liquid crystal (liquid crystal composition) LCb can be changed by applying a voltage across the electrodes E11 and E12. For example, the liquid crystal LCb can assume the planar state when a relatively high voltage is applied across the electrodes. When a relatively low voltage is applied across the electrodes, the liquid crystal LCb can assume the focal conic state. By applying an intermediate voltage across the electrodes, the liquid crystal LCb can assume the state where the planar state and the focal conic state are mixed. After stop of application of the voltage, these states of the liquid crystal LCb are stably held.

The selective reflection wavelength of the liquid crystal LCb is set in the blue wavelength region, as already described. Accordingly, when the liquid crystal LCb is in the planar state, the liquid crystal LCb selectively reflects the light in the blue wavelength range, and exhibits a blue appearance. When the liquid crystal LCb is in the focal conic state, the liquid crystal LCb becomes transparent. Therefore, the liquid crystal LCb can perform blue display. The manner of driving the liquid crystal element LE1 will be described later.

In the liquid crystal element LE1, the following relationship is satisfied between the refractive indexes of the substrate S11, the electrode E11 formed on the substrate S11 and the insulating film I11 formed on the substrate S11. Among these refractive indexes, a difference between the largest and smallest refractive indexes is in a range from 0 to 0.3. In other words, a difference between any two of the refractive indexes of the substrate S1, the electrode E11 and the insulating film I11 is in the range from 0 to 0.3.

Likewise, the following relationship is satisfied between the refractive indexes of the substrate S12, the electrode E12 formed on the substrate S12 and the insulating film I12 formed on the substrate S12. Among these refractive indexes, a difference between the largest and smallest refractive indexes is in a range from 0 to 0.3. In other words, a difference between any two of the refractive indexes of the substrate S12, the electrode E12 and the insulating film I12 is in the range from 0 to 0.3.

In the following description, the difference between the largest refractive index and the smallest refractive index among the refractive indexes of the substrate, the electrode formed on this substrate and the insulating film formed on this substrate, may be referred to as a “refractive index difference between the substrate, electrode and insulating film”, or may be merely referred to as a “refractive index difference”, hereinafter.

As will be seen from the experimental results described later, the refractive index difference between the substrate, electrode and insulating film affects the contrast of the liquid crystal element. As the refractive index difference decreases toward zero, the contrast is increased. The refractive index difference particularly affects the reflective index of the whole liquid crystal element LE1 when the liquid crystal layer Lb (the liquid crystal LCb in the liquid crystal layer) is transparent.

In the liquid crystal element LE1, the refractive index difference between the electrode E11, the insulating film I11 and substrate S11 as well as the refractive index difference between the electrode E12, insulating film I12 and substrate S12 are both such a relatively small values between 0 and 0.3. Therefore, the irregular reflection of light can be suppressed when liquid crystal layer Lb is transparent. Thereby, the reflective index of the whole liquid crystal element LE1 is low when the liquid crystal layer Lb is transparent, and in other words, the transparency of the whole liquid crystal element LE1 is high when the liquid crystal layer Lb is transparent. Thereby, the black of the light absorbing layer BK, which is arranged on the side remote from the observation side, can be properly displayed when the liquid crystal layer Lb is transparent. As a result, the contrast of the liquid crystal element LE1 can be increased.

In this embodiment, the refractive index difference between the electrode E11, the insulating film I11 and substrate S11 as well as the refractive index difference between the electrode E12; insulating film I12 and substrate S12 are both in the range between 0 and 0.3. However, only one of the refractive index differences may be in the range from 0 to 0.3. This can also suppress the irregular reflection of light when the liquid crystal layer Lb is transparent, and the contrast can be improved. If only one of the refractive index differences is set to be in the range from 0 to 0.3, it is preferable that the refractive index difference between the substrate S11, electrode E11 and insulating film I11 at the observation side is set to be in the range from 0 to 0.3, because this refractive index difference exerts a larger influence on the contrast.

The refractive index difference between the electrode E11, insulating film I11 and substrate S11 may be either equal to or different from the refractive index difference between the electrode E12, insulating film I12 and substrate S12. In either case, the good contrast can be achieved by setting at least one of the above refractive index differences in the range from 0 to 0.3. If the materials and steps for forming the electrode E12 and the insulating film I12 on the substrate S12 are the same as those for forming the electrode E11 and the insulating film I11 on the substrate S11, the foregoing two refractive index differences are usually equal to each other, the manufacturing efficiency of the liquid crystal element LE1 can be high, and the manufacturing cost of the liquid crystal element LE1 can be low.

(2) FIG. 2 is a schematic cross section of an example of a layered type liquid crystal element.

A layered type liquid crystal element LLE1 shown in FIG. 2 has three liquid crystal cells CB, CG and CR layered in this order.

The layered type liquid crystal element LLE1 in this example is utilized as a display element of the reflection type, and an image displayed by this display element is observed from the outer side (upper side in FIG. 2) of the liquid crystal cell CB. Accordingly, the liquid crystal cell CB is arranged at the side nearest to the display observation side (element observation side), and the liquid crystal cell CR is arranged in the position remotest from the observation side. A black light absorbing layer BK is arranged on the outer side of the liquid crystal cell CR disposed at the position remotest from the observation side. The layered type liquid crystal element LLE1 can perform full color display, as will be described later in greater detail.

Each of the liquid crystal cells CB, CG and CR has the same structure as that of the liquid crystal element LE1 shown in FIG. 1 except for that the light absorbing layer BK is not employed. In FIGS. 1 and 2, members having the substantially same functions bear the same reference numbers or symbols, respectively.

The liquid crystal cells CB, CG and CR are provided for displaying in blue, green and red, and have liquid crystal layers Lb, Lg and Lr, respectively. The liquid crystal layers Lb, Lg and Lr contain liquid crystal compositions LCb, LCg and LCr having the selective reflection wavelengths in the blue, green and red regions, respectively. Each of the liquid crystal compositions LCb, LCg and LCr in this example is the chiral nematic liquid crystal composition exhibiting the cholesteric phase in the room temperature.

In the liquid crystal cell CB, the liquid crystal layer Lb is held between the paired substrates S11 and S12. The transparent electrode E11, the insulating film I11 as the functional thin film and orientation film A11 are successively formed on the substrate S11. Also, the transparent electrode E12, the insulating film I12 as the functional thin film and orientation film A12 are successively formed on the substrate S12.

In the liquid crystal cell CG, similarly to the liquid crystal cell CB, the liquid crystal layer Lg is held between paired substrates, and the transparent electrode, the insulating film and the orientation film are successively formed on each substrate. In the liquid crystal cell CR, similarly to the liquid crystal cell CB, the liquid crystal layer Lr is held between paired substrates, and the transparent electrode, the insulating film and the orientation film are successively formed on each substrate.

The neighboring two liquid crystal cells are adhered together by an adhesive layer 2 arranged therebetween. The adhesive layer in this example is formed of double-coated adhesive tape. The adhesive on the double-coated adhesive tape may be acrylic adhesive. Instead of the double-coated adhesive tape, the adhesive layer may be an adhesive agent. The adhesive agent may be ultraviolet-curing resin, thermosetting silicon-contained resin or the like.

According to the layered type liquid crystal element LLE1 having the liquid crystal cells CB, CG and CR (liquid crystal layers Lb, Lg and Lr) layered together can selectively perform the display in blue, green and red as well as intermediate colors, and colors of mixture of two or three of above colors. As a result, the full color display can be performed. When the liquid crystal composition of all the liquid crystal cells (liquid crystal layers) is transparent, the black which is the color of the light absorbing layer BK arranged outside the liquid crystal cell CR is displayed. A method of driving the layered type liquid crystal element LLE1 will be described later.

In the layered type liquid crystal element LLE1, the refractive indexes of the substrate, the electrode formed on this substrate and the insulating film formed on this substrate are set to satisfy such a relationship that a difference between the largest and smallest refractive indexes is in a range from 0 to 0.3, similarly to the liquid crystal element LE1.

Thus, in the liquid crystal cell CB, the refractive index difference between the electrode E11, insulating film I11 and substrate S11 is in the range from 0 to 0.3, and the refractive index difference between the electrode E12, insulating film I12 and substrate S12 is in the range from 0 to 0.3. In the liquid crystal cells CG and CR, the refractive index different between the substrate, the electrode formed on this substrate and the insulating film formed on this substrate is likewise in the range from 0 to 0.3.

Therefore, in the layered type liquid crystal element LLE1, similarly to the liquid crystal element LE1, when one or more of the liquid crystal layers are transparent, the irregular reflection of light can be suppressed in the liquid crystal cell(s) having the transparent liquid crystal layer(s) so that transparency of the liquid crystal cell(s) having the transparent liquid crystal layer(s) can be high. Thereby, the layered type liquid crystal element LLE1 can perform the display with good contrast.

In this example, the refractive index difference between the substrate, the electrode formed on this substrate and the insulating film formed on this substrate is in the range from 0 to 0.3 in each of the liquid crystal cells CB, CG and CR. However, the refractive index difference may be in the range from 0 to 0.3, e.g., only in one of the liquid crystal cells. If the refractive index difference is in the range from 0 to 0.3 in at least one of the liquid crystal cells, the contrast can be high. For example, the refractive index difference may be in the range from 0 to 0.3 only in the liquid crystal cell CB, which is nearest to the observation side, and thus affects the contrast to the highest extent.

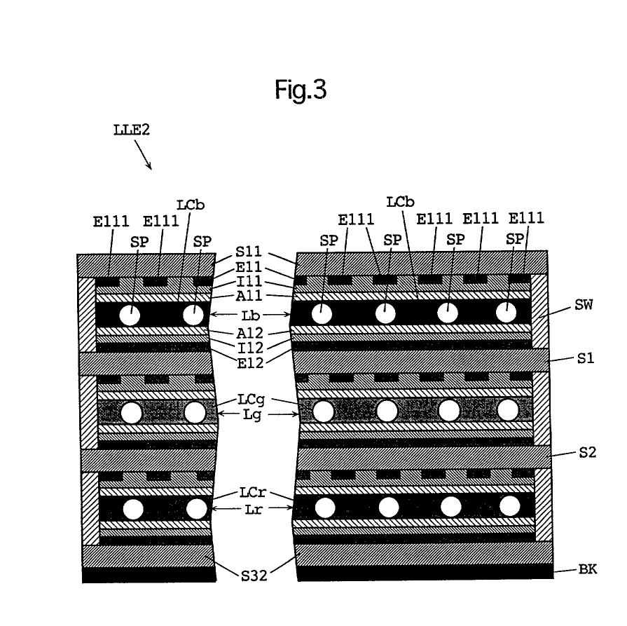

(3) In the layered type liquid crystal element, only one substrate may be disposed between the neighboring liquid crystal layers, and may be utilized commonly for holding these liquid crystal layers, as is done, e.g., in a layered type liquid crystal element LLE2 shown in FIG. 3.

In the layered type liquid crystal element LLE2 shown in FIG. 3, the substrate S1 is disposed between the neighboring liquid crystal layers Lb and Lg, and the substrate S2 is disposed between the neighboring liquid crystal layers Lg and Lr.

The liquid crystal layer Lb is held between the substrates S11 and S1. The liquid crystal layer Lg is held between the substrates S1 and S2. The liquid crystal layer Lr is held between the substrates S2 and S32. Thus, the substrate S1 is utilized commonly for holding the liquid crystal layers Lb and Lg and other purposes. Likewise, the substrate S2 is utilized commonly for holding the liquid crystal layers Lg and Lr and other purposes.

On the substrate S11, there are arranged the electrode E11, the insulating film I11 and the orientation film A11 provided for the liquid crystal layer Lb. On one of the surfaces of the substrate S1, there are arranged the electrode E12, the insulating film I12 and the orientation film A12 provided for the liquid crystal layer Lb. On the other surface of the substrate S1, there are arranged the electrode, insulating film and orientation film provided for the liquid crystal layer Lg. On one of the surfaces of the substrate S2, there are arranged the electrode, insulating film and orientation film provided for the liquid crystal layer Lg. On the other surface of the substrate S2, there are arranged the electrode, insulating film and orientation film provided for the liquid crystal layer Lr. On the substrate S32, there are arranged the electrode, insulating film and orientation film provided for the liquid crystal layer Lr.

In this layered type liquid crystal element LLE2, the refractive index difference between the substrate, the electrode, provided for the opposed liquid crystal layer, on this substrate and the insulating film, provided for this liquid crystal layer, on this substrate is in the range from 0 to 0.3, whereby the contrast can be high, similarly to the layered type liquid crystal element LLE1. Among the refractive index differences related to the plurality of substrates as well as the electrodes and insulating films thereon, at least one of the refractive index differences may be in the range from 0 to 0.3, whereby the high contrast can be achieved.

The layered type liquid crystal element LLE2 can be entirely thinner than the layered type liquid crystal element LLE1.

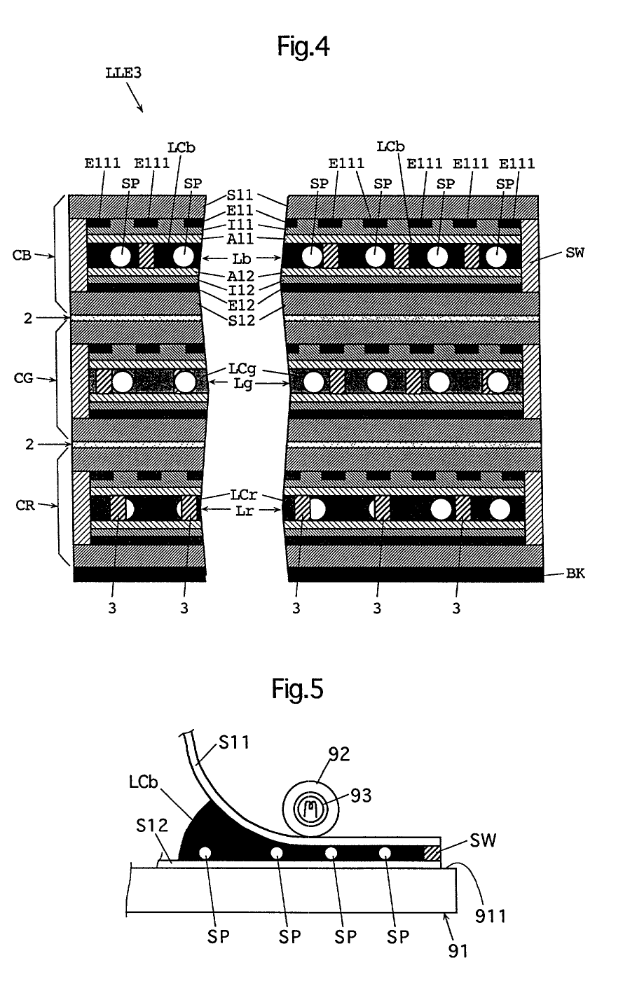

(4) In the liquid crystal element and the layered type liquid crystal elements of the invention, resin structures (e.g., columnar resin structures) 3 may be arranged between the paired substrates holding the liquid crystal layer therebetween, instead of or together with the spacers (see FIG. 4). In a layered type liquid crystal element LLE3 shown in FIG. 4, the resin structures 3 are provided for each liquid crystal layer in the same structure as that of the layered type liquid crystal element LLE1 shown in FIG. 2. The resin structures can be utilized for increasing the strength of the liquid crystal element or the whole liquid crystal cells, and for adhering the paired substrates holding the liquid crystal layer.

The resin structure may be made of a material which can be softened when heated, and can be solidified by cooling. An organic material which does not chemically react with the liquid crystal material, and has an appropriate elasticity is suitable for the material of the resin structures. The material of the resin structure may be a thermoplastic polymer material. The thermoplastic polymer material may be, e.g., polyvinyl dichloride resin, polyvinylidene chloride resin, polyvinyl acetate resin, methacrylate ester resin, polyacrylate ester resin, polystyrene resin, polyamide resin, polyethylene resin, polypropylene resin, fluororesin, polyurethane resin, polyacrylonitrile resin, polyvinyl ether resin, polyvinyl ketone resin, polyester resin, polyvinyl pyrolidone resin, saturated polyester resin, polycarbonate resin, chlorinated polyether resin or the like. The resin structure may be made of one or more of the above materials.

The resin structure may have a dot-like columnar form having a circular, square or elliptic section, although not restricted thereto.

The resin structures within the display region may be spaced from each other by a predetermined distance, and may be arranged, e.g., in a matrix form in accordance with a predetermined arrangement rule.

The dot-like resin structures may have sizes and pitches which are appropriately determined in accordance with the sizes of the liquid crystal element (liquid crystal display element) and the pixel resolution.

If the dot-like resin structures is arranged between the electrodes (substrates) with priority, the aperture ratio can be high.

It is preferable that the resin structures are arranged and disposed in a pattern other than a random pattern, which may be caused, e.g., by dispersion of the resin material. More specifically, it is preferable that the arrangement pattern of the resin structures is determined in accordance with appropriate arrangement rules for keeping an appropriate gap between the substrates, and not for impeding image display. In the preferable arrangement of the resin structures as described above, the resin structures may be equally spaced from each other, the resin structures may be spaced by a distance which gradually increases in accordance with the position, or a predetermined pattern of arrangement of the resin structures may be repeated regularly. The resin structures may take the form of stripes spaced by a predetermined distance from each other.

(5) An example of a method of manufacturing the layered type liquid crystal element LLE1 shown in FIG. 2 will now be described.

First, the respective liquid crystal cells CB, CG and CR are formed. The liquid crystal cell CB can be formed in the following manner.

For manufacturing the liquid crystal cell CB, the transparent electrodes E11 and E12 having the plurality of belt-like transparent electrode portions are formed on the transparent substrates S11 and S12, respectively. The transparent electrode can be formed by forming a conductive film (e.g., ITO film) on the substrate by a sputtering method or the like, and then patterning the conductive film by a photolithography method and other methods into predetermined configurations. A commercially available substrate on which a conductive film is formed uniformly may be employed, in which case the electrode of a predetermined configuration can be formed by patterning the conductive film.

Then, the insulating film I11 and the orientation film A11 are successively formed on the electrode E11 of the substrate S11. On the electrode E12 of the substrate S12, the insulating film I12 and the orientation film A12 are successively formed.

The insulating film and the orientation films can be formed by the known method such as a sputtering method, a spin coat method, a roll coat method or a vapor deposition method with appropriate film formation materials.

Then, an annular wall made of resin such as ultraviolet-curing resin or thermosetting resin is formed on the peripheral portion of one of the substrates S11 and S12. The wall made of this resin will form the seal wall SW for preventing leakage of the liquid crystal. This resin wall can be formed by applying the resin onto the substrate from the nozzle by the dispenser method or ink-jet method. The resin wall can be formed by a printing method using a screen or a metal mask. The resin wall can also be formed by a transfer method, in which resin is supplied onto a flat plate or a roller, and then is transferred onto the substrate.

If the resin structures to be arranged between the substrates are employed as described before, the resin structures, which have predetermined configurations and are patterned into a predetermined arrangement form, are formed on, e.g., the substrate other than the substrate provided with the resin wall forming the seal wall. The resin structures can be formed by a printing method, in which a resin material paste (prepared, e.g., by dissolving resin into solvent) is squeezed out by a squeegee via a screen or a metal mask onto the substrate. The resin structures can be formed by a method such as a dispenser method or an ink jet method in which the resin material is supplied onto the substrate from a nozzle, or a transfer method in which the resin material is supplied onto a flat plate or roller, and then is transferred onto the substrate. It is preferable that each of the resin structures, at this time in the forming process of the liquid crystal cell, has a height larger than the desired thickness of the liquid crystal layer for adhering the substrates together with the resin structures to be arranged between the substrates.

Then, the spacers SP are dispersed on the surface of at least one of the substrates S11 and S12 by a known method.

Then, a predetermined amount of droplets of the liquid crystal LCb is applied onto an end portion of one of the substrates.

Then, the end portion of the other substrate is laid over the end portion of the substrate carrying the liquid crystal LCb, and both the substrates are overlaid together while spreading the liquid crystal from the above end portion toward the other end portion. When overlaying the substrates, a heat and a pressure are applied. For example, a fixing device shown in FIG. 5 is used for overlaying the substrates.

More specifically, the substrate carrying the liquid crystal is laid over a flat surface 911 of a substrate carrier member 911. The end portion of the other substrate is laid over the end portion of the substrate on the carrier member 91, and these substrates are overlaid together by a roller 92 internally provided with a heater 93. For example, the roller 92 is moved in a predetermined direction (leftward in FIG. 5) at a predetermined speed so that the heat of the heater 93 and the pressure by the roller 92 are applied to both the substrates for overlaying them.

By overlaying the substrates together in the above manner, the liquid crystal cell can be manufactured with high accuracy even if the substrate is a flexible substrate such as a film substrate.

By applying the pressure and spreading the liquid crystal while overlaying the substrates, it is possible to suppress mixing of bubbles into the liquid crystal layer Lb.

If the seal wall is made of thermosetting resin, this can be hardened by the above heating. If the resin structures are made of a thermoplastic polymer material, the resin structures can be heated in the above manner, and then is cooled so that the resin structures are softened, and then is solidified, and thereby the resin structures can be adhered onto the opposite substrates. If the seal wall and/or the resin structures are made of materials having heat softening properties, the application of pressure is kept to push the substrates against each other until the material is cooled to a temperature lower than the softening temperature. If the seal wall is made of a photosetting resin, both the substrates are overlaid, and then the seal wall material is hardened by light irradiation.

Thereby, the liquid crystal cell CB of the structure shown in FIG. 2 can be produced. The liquid crystal cells CG and CR can be manufactured in a similar manner.

The three liquid crystal cells prepared in this manner are adhered together in the predetermined order by an adhesive material such as adhesive or double-coated adhesive tape, and the light absorbing layer BK is formed on the outer side of the liquid crystal cell CR so that the layered type liquid crystal element LLE1 is manufactured.

Instead of dispersing the spacers on the substrate in advance to the fixing of substrates, the spacers may be dispersed within the liquid crystal before being dropped onto the substrate. Even in this manner, the spacers can be arranged between the substrates, and the thickness of the liquid crystal can be adjusted.

The liquid crystal element LE1 in FIG. 1, the layered type liquid crystal element LE2 in FIG. 3 and the layered type liquid crystal element LLE3 in FIG. 4 can be manufactured in the manner similar to the above.

(6) Description will now be given on the method of driving the layered type liquid crystal element LLE1 shown in FIG. 2.

As described above, the electrodes of each liquid crystal cell have a matrix structure. Therefore, by performing simple matrix drive of each liquid crystal element, desired characters, graphics and others can be displayed.

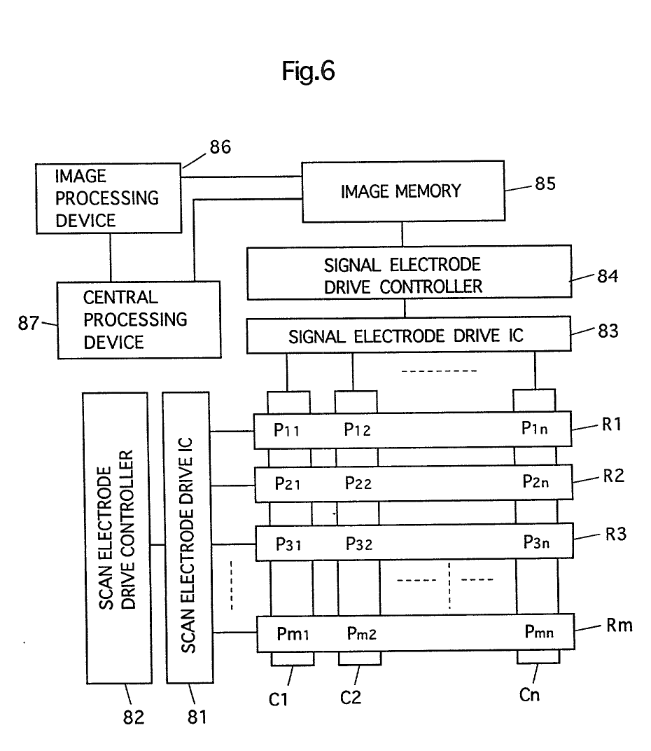

A manner of the simple matrix drive of the liquid crystal cell CB will now be described with reference to FIG. 6.

Signal electrodes (column electrodes) C1-Cn (n: natural number) in FIG. 6 correspond the respective belt-like electrode portions E111 of the electrode E11 shown in FIG. 2. Scan electrodes (row electrodes) R1-Rm (m: natural number) in FIG. 6 correspond to the respective belt-like electrode portions of the electrode E12 in FIG. 2.

In the liquid crystal cell CB, the orientation of the liquid crystal can be changed by the following region unit. This region unit has a cross region where one scan electrode and one signal electrode cross each other, and a peripheral region of the cross region. In the liquid crystal cell CB, each pixel is formed of the cross region where one scan electrode and one signal electrode cross each other, and the peripheral region. The pixel at the position of the crossing between the scan and signal electrodes Rp and Rq is represented as a pixel Ppq, where p is a natural number satisfying a relationship of (1≦p≦m) and q is a natural number satisfying a relationship of (1≦q≦n).

The liquid crystal cell CB can display an image based on the image data, which is written into an image memory 85 by an image processing device 86 and a central processing device 87, in the following manner.

The scan electrode drive IC 81 issues a select signal to a predetermined one of the scan electrodes R1-Rm for setting it to the selected state, and issues non-selection signals to the others for setting them to the unselected state. The scan electrode drive IC 81 switches the electrode to be selected at predetermined time intervals, and the respective scan electrodes are successively set to the selected state. This control is performed by the scan electrode drive controller 82.

For rewriting the respective drive target pixels on the scan electrode in the selected state, the signal electrode drive IC 83 simultaneously issues signal voltages corresponding to image data of the respective drive target pixels to the respective signal electrodes, and simultaneously changes the orientations of the liquid crystal of each drive target pixel in accordance with the image data. For example, when the scan electrode R1 is selected, the orientations of the liquid crystal of the drive target pixels P11-P1n on the scan electrode R1 are changed in accordance with the pixel data of the respective drive target pixels. The voltage difference between the voltage applied to the scan electrode of the drive target pixel, and the voltage applied to the signal electrode and corresponding to the image data, is applied to the liquid crystal of the drive target pixel. Therefore, the orientation of the liquid crystal of the drive target pixel is changed in accordance with the image data. Every time the selected scan electrode is changed, the signal electrode drive IC 83 changes the orientations of the liquid crystal of the drive target pixels in accordance with the image data. This control is performed by the signal electrode drive controller 84 in parallel with the operation of reading image data from the image memory 85.

As described above, the liquid crystal of the drive target pixel is supplied with the voltage corresponding to the image data (tone data) of the drive target pixel. Therefore, in accordance with the image data of the drive target pixel, the liquid crystal of the drive target pixel can be set to the planar state, the focal conic state or the state where these states are mixed at a ratio corresponding to the display tone. Accordingly, gradation display corresponding to the image data can be performed.

The liquid crystal cells CR and CG can be driven in accordance with the image data in a similar manner, and thereby can perform the gradation display. By driving the three liquid crystal cells CB, CG and CR in accordance with the image data, the full color display can be performed.

The liquid crystal element LE1 in FIG. 1, the layered type liquid crystal element LLE2 in FIG. 3 and the layered type liquid crystal element LLE3 in FIG. 4 can be driven in the manner similar to the above.

(7) Description will be given on experimental examples 1-5, in which layered type liquid crystal elements according to the invention were manufactured, and the contrasts thereof were determined. Each of the layered type liquid crystal elements in the experimental examples 1-5 had the structure, similar to that of the layered type liquid crystal element LLE1 shown in FIG. 2, having three layered liquid crystal cells for red, green and blue display. In each of the layered type liquid crystal elements in the experimental examples 1-5, the refractive index difference between the substrate, the electrode on this substrate and the insulating film on this substrate was in the range from 0 to 0.3.

For comparison with the layered type liquid crystal element according to the invention, layered type liquid crystal elements each having the refractive index difference larger than 0.3 were manufactured, and contrasts thereof were determined in comparative examples 1 and 2. These comparative examples 1 and 2 will also be discussed.

(7-1) Experimental Example 1

First, the liquid crystal cells for red, green and blue displays, which include the liquid crystal layers for red, green and blue displays, respectively, were manufactured in the following manner.

Liquid Crystal Cell For Red Display (liquid crystal cell to be arranged at the position remotest from the observation side) Polycarbonate (PC) films, on which transparent electrodes were already formed, were employed as a pair of substrates (first and second substrates) for forming the liquid crystal cell for red display, and the insulating films and others were formed on the substrates in the following manner.

Each of the first and second substrates had the refractive index of 1.58. Each of the transparent electrodes on the first and second substrates had the refractive index of 1.60.

An insulating film of 2000 Å in thickness made of MgF₂ was formed on the transparent electrode arranged on the first substrate by the vapor deposition method. Thereafter, an orientation film of 800 Å in thickness made of a polyimide-contained material was formed on the insulating film. AL4552 (manufactured by JSR Corp.) was employed as the material of the orientation film.

The insulating film formed on the first substrate had the refractive index of 1.40. In the experimental example 1, therefore, the refractive index difference between the first substrate, the electrode on the first substrate and the insulating film on the first substrate was equal to 0.20.

Then, spacers (manufactured by Sekisui Finechemical Co., Ltd.) of 9 μm in diameter were dispersed over the orientation film on the first substrate.

Similarly to the first substrate, an insulating film of 2000 Å in thickness made of MgF₂ and an orientation film of 800 Å in thickness made of a polyimide-contained material were successively formed on the second substrate.

The insulating film formed on the second substrate had the refractive index of 1.40. In the experimental example 1, therefore, the refractive index difference between the second substrate, the electrode on the second substrate and the insulating film on the second substrate was equal to 0.20.

Then, the seal material XN21S (manufactured by Mitsui Chemicals Co., Ltd.) was applied by screen printing method onto the peripheral portion of the first substrates so that a frame-like wall of a predetermined height was formed. The wall made of this resin will be the seal wall for preventing leakage of the liquid crystal in a later stage.

Thereafter, the liquid crystal composition LCr of an amount, which corresponded to the area of the region surrounded by the seal wall on the first substrate and the height of this seal wall, was applied onto the region surrounded by the seal wall on the first substrate. The liquid crystal composition LCr thus applied was as follows.

The liquid crystal composition LCr was chiral nematic liquid crystal composition formed by adding chiral agent S-811 (manufactured by Merck & Co.) at 17% by weight to nematic liquid crystal composition having refractive index anisotropy Δn of 0.15 and dielectric anisotropy Δε of 12. The liquid crystal composition LCr had the selective reflection wavelengths of about 680 nm (red region), and exhibited the cholesteric phase in the room temperature.

Then, the first and second substrates were fixed together by the fixing device shown in FIG. 5 with the liquid crystal composition LCr therebetween. The liquid crystal cell thus prepared was subjected to heating at 150° C. for one hour so that the seal material was melted and adhered onto the first and second substrates. Thereafter, the liquid crystal cell was cooled to the room temperature so that the liquid crystal cell for red display was completed.

Liquid Crystal Cell For Green Display (liquid crystal cell to be arranged in the middle position)

The liquid crystal cell for green display was prepared similarly to the liquid crystal cell for red display except for the followings.

The liquid crystal cell for green display employed spacers of 7 μm in diameter instead of spacers of 9 μm in diameter. Thus, in the liquid crystal cell for green display, the liquid crystal layer had thickness of 7 μm.

The liquid crystal cell for green display employed liquid crystal composition LCg as the liquid crystal held between the two substrates. The liquid crystal composition LCg was chiral nematic liquid crystal composition formed by adding chiral agent S-811 (manufactured by Merck & Co.) at 22% by weight to nematic liquid crystal composition having refractive index anisotropy Δn of 0.16 and dielectric anisotropy Δε of 11. The liquid crystal composition LCg had the selective reflection wavelengths of about 560 nm (green region), and exhibited the cholesteric phase in the room temperature.

Liquid Crystal Cell For Blue Display (liquid crystal cell to be arranged at the position nearest to the observation side)

The liquid crystal cell for blue display was prepared similarly to the liquid crystal cell for red display except for the followings.

The liquid crystal cell for blue display employed spacers of 5 μm in diameter instead of spacers of 9 μm in diameter. Thus, in the liquid crystal cell for blue display, the liquid crystal layer had thickness of 5 μm.

The liquid crystal cell for blue display employed liquid crystal composition LCb as the liquid crystal held between the two substrates. The liquid crystal composition LCb was chiral nematic liquid crystal composition formed by adding chiral agent S-811 (manufactured by Merck & Co.) at 26% by weight to nematic liquid crystal composition having refractive index anisotropy Δn of 0.17 and dielectric anisotropy Δε of 11. The liquid crystal composition LCb had the selective reflection wavelengths of about 480 nm (blue region), and exhibited the cholesteric phase in the room temperature.

The liquid crystal cells for red, green and blue displays thus prepared were adhered together in this order.

The neighboring liquid crystal cells were adhered together. Then, the black light absorbing film was formed on the outer side of the liquid crystal cell for red display, which was located remotest from the observation side.

In these manners, the layered type liquid crystal element was prepared. In the layered type liquid crystal element of the experimental example 1, the refractive index difference between the substrate, the electrode on this substrate and the insulating film on this substrate was equal to 0.2 in each of the liquid crystal cell.

The characteristics of the layered type liquid crystal element thus prepared were measured by the spectrocolorimeter CM-3700d (manufactured by Minolta Co., Ltd.). Y-value, i.e., a luminous reflectance, was measured as following manner. Y-value (white) was measured when each of the liquid crystal layers of the respective liquid crystal cells was in the selective reflection state (planar state), and therefore the white display was performed. Also, Y-value (black) was measured when each of the liquid crystal layers of the respective liquid crystal cells was in the transparent state (focal conic state), and therefore the black display was performed. When each of the liquid crystal layers of the respective liquid crystal cells was transparent, the color (black) of the light absorbing film arranged on the outer side of the liquid crystal cell for red display was displayed. The contrast [=(Y-value (white))/(Y-value (black))] was calculated from the Y-value (white) and the Y-value (black). The larger value in contrast represents better contrast.

The layered type liquid crystal element of the experimental example 1 exhibited good contrast equal to 7. In particular, the black display characteristic was good, and therefore the contrast was good. More specifically, when each liquid crystal layer was transparent, the degree of light scattering was small so that the transparency was high, and therefore the Y-value (black) was small, as a result, the contrast was high.

In the layered type liquid crystal element of the experimental example 1, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The (drive voltages for setting the liquid crystal cell for blue display to the selective reflection state and the transparent state were equal to 95 V and 65 V, respectively.

The drive voltage, which was used when measuring the characteristics of the layered type liquid crystal element of the experimental example 1, of each liquid crystal cell was a pulse voltage having a pulse width of 5 milliseconds. This is true also with respect to experimental examples 2-5 and comparative examples 1 and 2, which will be described later.

(7-2) Experimental Example 2

In the experimental example 2, the layered type liquid crystal element, in which the liquid crystal cells for red, green and blue displays were layered in this order, was manufactured similarly to the experimental example 1 except for the followings.

In the experimental example 2, polyarylate (PA) films having a refractive index of 1.60 were employed as the first and second substrates of each liquid crystal cell. Each of the transparent electrodes on the first and second substrates had the refractive index of 1.80. Further, the insulating film of 1000 Å in thickness, made of YF₃ and having the refractive index of 1.50, was formed on each of the first and second substrates in each liquid crystal cell.

In the layered type liquid crystal element of the experimental example 2, therefore, the refractive index difference between the substrate, the electrode on this substrate and the insulating film on this substrate was equal to 0.30 in each of the liquid crystal cells.

The display characteristics of the layered type liquid crystal element prepared in the experimental example 2 were measured in the same manner as the experimental example 1.

The layered type liquid crystal element of the experimental example 2 exhibited good contrast equal to 5. In particular, the black display characteristic was good, and therefore the contrast was good.

In the layered type liquid crystal element of the experimental example 2, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The drive voltages for setting the liquid crystal cell for blue display to the selective reflection state and the transparent state were equal to 95 V and 65 V, respectively.

(7-3) Experimental Example 3

In the experimental example 3, the layered type liquid crystal element, in which the liquid crystal cells for red, green and blue displays were layered in this order, was manufactured similarly to the experimental example 1 except for the followings.

In the experimental example 3, polyether ether ketone (PEEK) films having a refractive index of 1.66 were employed as the first and second substrates of each liquid crystal cell. Each of the transparent electrodes on the first and second substrates had the refractive index of 1.70. Further, the insulating film of 1000 Å in thickness, which was made of HfO₂ and having the refractive index of 1.90, was formed on each of the first and second substrates in each liquid crystal cell.

In the layered type liquid crystal element of the experimental example 3, therefore, the refractive index difference between the substrate, the electrode on this substrate and the insulating film on this substrate was equal to 0.24 in each of the liquid crystal cells.

The display characteristics of the layered type liquid crystal element prepared in the experimental example 3 were measured in the same manner as the experimental example 1.

The layered type liquid crystal element of the experimental example 3 exhibited good contrast equal to 6.5. In particular, the black display characteristic was good, and therefore the contrast was good.

In the layered type liquid crystal element of the experimental example 3, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The drive voltages for setting the liquid crystal cell for blue display to the selective reflection state and the transparent state were equal to 95 V and 65 V, respectively.

(7-4) Experimental Example 4

In the experimental example 4, the layered type liquid crystal element, in which the liquid crystal cells for red, green and blue displays were layered in this order, was manufactured similarly to the experimental example 1 except for the followings.

In the experimental example 4, polyether sulfone (PES) films having a refractive index of 1.65 were employed as the first and second substrates of each liquid crystal cell. Each of the transparent electrodes on the first and second substrates had the refractive index of 1.70. Further, the insulating film of 1000 Å in thickness, made of an inorganic material “Substance M2” manufactured by Merk Co., Ltd. and having the refractive index of 1.70, was formed on each of the first and second substrates in each liquid crystal cell.

In the layered type liquid crystal element of the experimental example 4, therefore, the refractive index difference between the substrate, the electrode on this substrate and the insulating film on this substrate was equal to 0.05 in each of the liquid crystal cells.

The display characteristics of the layered type liquid crystal element prepared in the experimental example 4 were measured in the same manner as the experimental example 1.

The layered type liquid crystal element of the experimental example 4 exhibited good contrast equal to 7.5. In particular, the black display characteristic was good, and therefore the contrast was good.

In the layered type liquid crystal element of the experimental example 4, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The drive voltages for setting the liquid crystal cell for blue display to the selective reflection state and the transparent state were equal to 95 V and 65 V, respectively.

(7-5) Experimental Example 5

In the experimental example 5, the layered type liquid crystal element, in which the liquid crystal cells for red, green and blue displays were layered in this order, was manufactured similarly to the experimental example 1 except for the followings.

In the experimental example 5, O-PET films manufactured by Kanebo Co., Ltd. and having a refractive index of 1.63 were employed as the first and second substrates of each liquid crystal cell. Each of the transparent electrodes on the first and second substrates had the refractive index of 1.90. Further, the insulating film.of 1000 Å in thickness, made of Al₂O₃ and having the refractive index of 1.60, was formed on each of the first and second substrates in each liquid crystal cell.

In the layered type liquid crystal element of the experimental example 5, therefore, the refractive index difference between the substrate, the electrode on this substrate and the insulating film on this substrate was equal to 0.30 in each of the liquid crystal cells.

The display characteristics of the layered type liquid crystal element prepared in the experimental example 5 were measured in the same manner as the experimental example 1.

The layered type liquid crystal element of the experimental example 5 exhibited good contrast equal to 5. In particular, the black display characteristic was good, and therefore the contrast was improved.

In the layered type liquid crystal element of the experimental example 5, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The drive voltages for setting the liquid crystal cell for blue display to the selective reflection state and the transparent state were equal to 95 V and 65 V, respectively.

(7-6) Comparative Example 1 (Comparative Experimental Example 1)

In the comparative example 1, the layered type liquid crystal element, in which the liquid crystal cells for red, green and blue displays were layered in this order, was manufactured similarly to the experimental example 1 except for the followings.

In the comparative example 1, polyethylene terephthalate (PET) films having a refractive index of 1.49 were employed as the first and second substrates of each liquid crystal cell. Each of the transparent electrodes on the first and second substrates had the refractive index of 2.4. Further, the insulating film of 1000 Å in thickness, made of AlF₃ and having the refractive index of 1.35, was formed on each of the first and second substrates in each liquid crystal cell.

In the layered type liquid crystal element of the comparative example 1, therefore, the refractive index difference between the substrate, the electrode on this substrate and the insulating film on this substrate was equal to 1.05 in each of the liquid crystal cells.

The display characteristics of the layered type liquid crystal element prepared in the comparative example 1 were measured in the same manner as the experimental example 1.

The contrast of the layered type liquid crystal element of the comparative example 1 was equal to 2, and therefore was lower than that of the layered type liquid crystal elements in the foregoing experimental examples 1-5. In particular, the black display characteristic was low, and therefore the contrast was low. More specifically, when each liquid crystal layer was transparent, the degree of light scattering was large so that the transparency was low, and therefore the Y-value (black) was large, as a result, the contrast was low.

In the layered type liquid crystal element of the comparative example 1, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The drive voltages for setting the liquid crystal cell for blue display to the selective reflection state and the transparent state were equal to 95 V and 65 V, respectively.

(7-7) Comparative Example 2 (Comparative Experimental Example 2)

In the comparative example 2, the layered type liquid crystal element, in which the liquid crystal cells for red, green and blue displays were layered in this order, was manufactured similarly to the experimental example 1 except for the followings.

In the comparative example 2, polyethylene terephthalate (PET) films having a refractive index of 1.49 were employed as the first and second substrates of each liquid crystal cell. Each of the transparent electrodes on the first and second substrates had the refractive index of 2.2. Further, the insulating film of 1000 Å in thickness, made of AlF₃ and having the refractive index of 1.35, was formed on each of the first and second substrates in each liquid crystal cell.

In the layered type liquid crystal element of the comparative example 2, therefore, the refractive index difference between the substrate, the electrode on this substrate and the insulating film on this substrate was equal to 0.85 in each of the liquid crystal cells.

The display characteristics of the layered type liquid crystal element prepared in the comparative example 2 were measured in the same manner as the experimental example 1.

The contrast of the layered type liquid crystal element of the comparative example 2 was equal to 2.5, and therefore was lower than that of the layered type liquid crystal elements in the foregoing experimental examples 1-5. In particular, the black display characteristic was low, and therefore the contrast was low.

In the layered type liquid crystal element of the comparative example 2, the drive voltages for setting the liquid crystal cell for red display to the selective reflection state and the transparent state were equal to 85 V and 55 V, respectively. The drive voltages for setting the liquid crystal cell for green display to the selective reflection state and the transparent state were equal to 90 V and 60 V, respectively. The drive voltages for setting the liquid crystal cell for blue display to the selective reflection state and the transparent state were equal to 95 V and 65 V, respectively.

The results of the experimental examples 1-5 as well as the comparative examples 1 and 2 are summarized in the following table 1.

TABLE 1

| | E-RI* | I-RI* | S-RI* | RID* | contrast |
|---|---|---|---|---|---|
| EX1 | 1.60 | 1.40 | 1.58 | 0.20 | 7 |
| EX2 | 1.80 | 1.50 | 1.60 | 0.30 | 5 |
| EX3 | 1.70 | 1.90 | 1.66 | 0.24 | 6.5 |
| EX4 | 1.70 | 1.70 | 1.65 | 0.05 | 7.5 |
| EX5 | 1.90 | 1.60 | 1.63 | 0.30 | 5 |
| CE1 | 2.4 | 1.35 | 1.49 | 1.05 | 2 |
| CE2 | 2.2 | 1.35 | 1.49 | 0.85 | 2.5 |

E-RI*: refractive index of electrode
I-RI*: refractive index of insulating film
S-RI*: refractive index of substrate
RID*: refractive index difference
EX: experimental example
CE: comparative example

The following can be understood from the table 1. The layered type liquid crystal elements of the experimental examples 1-5 according to the invention, each in which the refractive index difference between the largest refractive index and the smallest refractive index among the refractive indexes of the substrate, electrode and insulating film was 0.3 or less, achieve relatively well contrast. If the refractive index difference is substantially 0.25 or less, the contrast is further improved. The refractive index difference of 0.2 or less can further improve the contrast.

Whichever the refractive index is largest and whichever refractive index is smallest among the refractive indexes of the substrate, electrode and insulating layer, the refractive index difference of 0.3 or less can achieve relatively well contrast.

As the refractive index decreases toward 0, the contrast is substantially improved.

By setting the refractive index of the electrode in a range from 1.6 to 2.4, the contrast can be improved, although it depends on the refractive indexes of the insulating film and the substrate. By setting the refractive index of the insulating film in a range from 1.4 to 2.0, the contrast can be improved, although it depends on the refractive indexes of the electrode and the substrate. By setting the refractive index of the substrate in a range from 1.55 to 1.7, the contrast can be improved, although it depends on the refractive indexes of the electrode and the insulating film.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A liquid crystal element, wherein
a liquid crystal layer is held between a pair of substrates, an electrode and a functional thin film are formed on at least one of said substrates, and a refractive index difference between a largest refractive index and a smallest refractive index among refractive indexes of said substrate, said electrode formed on said substrate and said functional thin film formed on said substrate is in a range from 0 to 0.3.

2. The liquid crystal element according to claim 1, wherein
the refractive index of said electrode is in a range from 1.6 to 2.4.

3. The liquid crystal element according to claim 1, wherein
the refractive index of said functional thin film is in a range from 1.4 to 2.0.

4. The liquid crystal element according to claim 1, wherein
the refractive index of said substrate is in a range from 1.55 to 1.7.

5. The liquid crystal element according to claim 1, wherein
said functional thin film is an insulating film.

6. The liquid crystal element according to claim 3, wherein
said functional thin film is an insulating film.

7. A layered type liquid crystal element, in which a plurality of liquid crystal layers are layered, each of said liquid crystal layers is held between a pair of substrates, an electrode and a functional thin film are formed on at least one of said substrates, and a refractive index difference between a largest refractive index and a smallest refractive index among refractive indexes of said substrate, said electrode formed on said substrate and said functional thin film formed on said substrate is in a range from 0 to 0.3.

8. The layered type liquid crystal element according to claim 7, wherein
the refractive index of said electrode is in a range from 1.6 to 2.4.

9. The layered type liquid crystal element according to claim 7, wherein
the refractive index of said functional thin film is in a range from 1.4 to 2.0.

10. The layered type liquid crystal element according to claim 7, wherein
the refractive index of said substrate is in a range from 1.55 to 1.7.

11. The layered type liquid crystal element according to claim 7, wherein
said functional thin film is an insulating film.

12. The layered type liquid crystal element according to claim 9, wherein
said functional thin film is an insulating film.
